(19) United States
(12) Patent Application Publication
(10) Pub. No.: US 2003/0154870 A1
(43) Pub. Date: Aug. 21, 2003

(54) Process and device for inking an engraved printing plate from an ink tank

(75) Inventor: Laurent De Volder, Aalter (BE)

Correspondence Address: JACOBSON HOLMAN PLLC, 400 SEVENTH STREET N.W., SUITE 600, WASHINGTON, DC, 20004, US

(73) Assignee: PRINTING INTERNATIONAL N.V., a corporation of Belgium

(21) Appl. No.: 10/233,678

(22) Filed: Sep. 4, 2002

Related U.S. Application Data
(63) Continuation of application No. 09/196,249, filed on Nov. 20, 1998, now abandoned.

(30) Foreign Application Priority Data
Nov. 21, 1997 (BE) 09700937

(51) Int. Cl. B41M 1/10

(52) U.S. Cl. 101/170

(57) ABSTRACT

The invention concerns a process for inking an engraved printing plate from an ink tank and for scraping off the ink in dab printing, characterised in that a doctor blade (8) is used, of which at least the bottom edge, which comes into contact with the printing plate (9), is adjusted with respect to the printing plate (9) at a negative angle, measured with respect to the portion of the printing plate that is inked and to be scraped off.

This invention relates to a process for inking an engraved printing plate from an ink tank and scraping off the ink in dab printing.

In the technique which is known as “dab printing”, an engraved printing plate is used, which in a first stage is inked over its entire surface, whereupon with a doctor blade the excess ink is scraped off, and collected in an ink duct or the like. The ink thus exclusively remains in the engraved parts.

The different operations involved in this, may be summarized as follows:

1. The doctor blade holder with slab is removed from the printing plate and is kept during the inking stage, at a distance from the printing plate.

2. The doctor blade holder with slab is moved during the inking stage, with respect to the printing plate, in the longitudinal direction thereof.

3. After the inking stage, the doctor blade is brought into contact with the printing plate.

4. The doctor blade is moved with respect to the printing plate, the ink is scraped off, except in the engraved portions, and is collected in an ink duct.

It will be clear that the relative movements of the doctor blade holder with slab, with respect to the printing plate, are the result from both a moving of these parts with respect to a stationary printing plate, and the reverse, and that consequently both the printing plate and the doctor blade and the slab can be moved in opposite sense.

The techniques which are generally applied and briefly described, show a series of disadvantages which can be summarized as follows:

a) The doctor blade is always adjusted in such a way with respect to the printing plate, that it forms a sharp angle with this plate, with the portion of the printing plate that has been inked and must yet be scraped off.

b) The printing plate is subjected to high wear, because of the pressure exerted by the doctor blade on the printing plate. A good scraping off of the ink is indeed an absolute requirement, and this requires, at the installation of the doctor blade as described sub a), a high pressure of the doctor blade on the printing plate.

c) Each time, two movements are required, which can be summarized as follows: doctor blade knife up/down during the relative movements of the doctor blade with respect to the printing plate.

d) Due to these double movements, a “closed inking chamber” is difficult to use.

It is now the aim of the invention to correct the disadvantages of this known technique and to prescribe a process and a device ensuring with technically reliable means, an increased life of the printing plate, and enabling a very comprehensive simplification of the above described steps.

In order to make this possible according to the invention, a doctor blade is used, of which at least the bottom edge which is contacting the plate, is adjusted with respect to this plate, at a negative angle, measured with respect to the inked portion of the printing plate to be scraped off, and without changing the position of the doctor blade, a relative movement of the doctor blade with respect to the printing plate is generated, on the one hand, in a direction to ink the printing plate, and on the other hand, in the other direction, to scrape off the ink from the printing plate.

Still according to the invention, for said negative angle a value between 90° and 180° is selected.

The invention also relates to a device for the application of the process according to the invention.

This description is exclusively given as an example and does not limit the invention. The reference numbers relate to the attached figures.

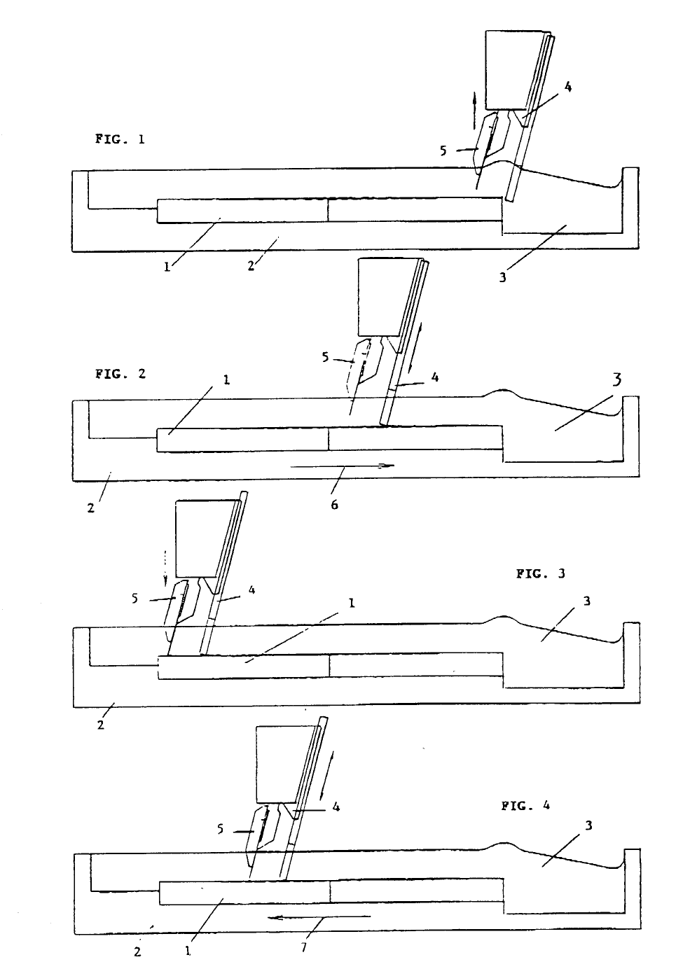

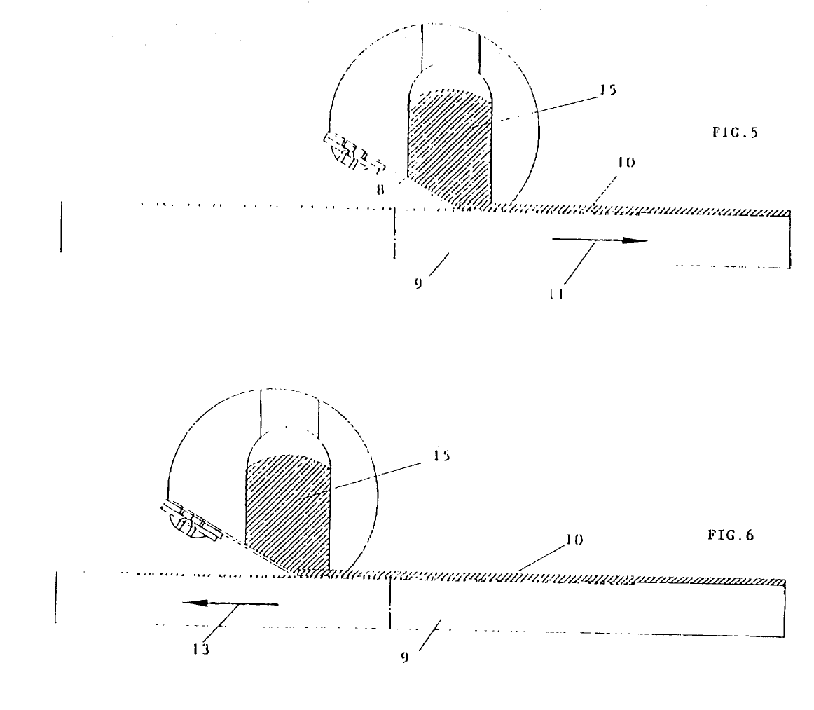

FIGS. 1-4 schematically illustrate the different stages of the inking of a printing plate in a device of the usual type.

FIGS. 5-6 illustrate two stages of the process in a device built according to the principle underlying the invention, whereby the printing plate is moved.

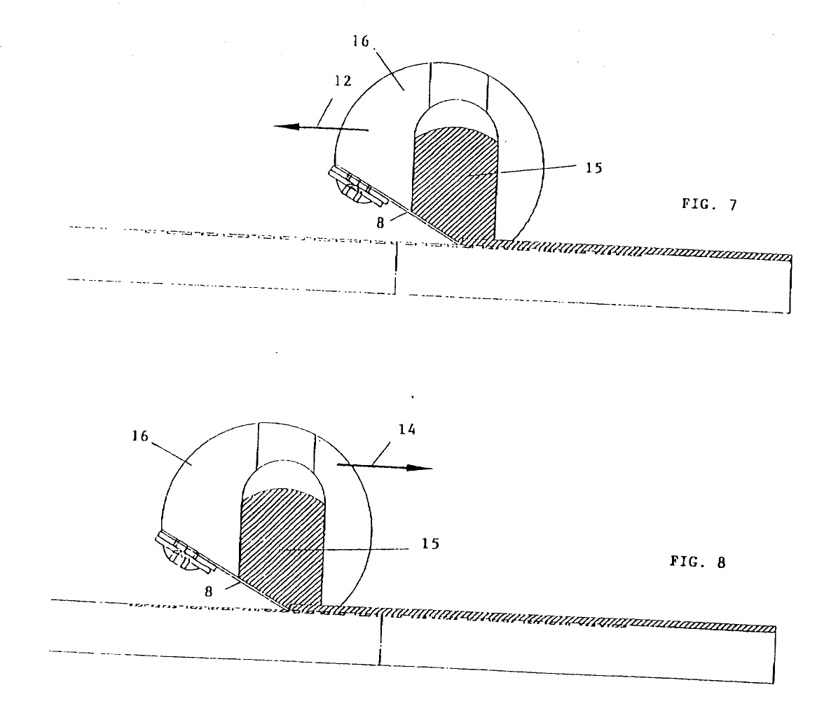

FIGS. 7-8 illustrate two stages of the process in a device built according to the principle underlying the invention, whereby the doctor blade and the ink tank are moved.

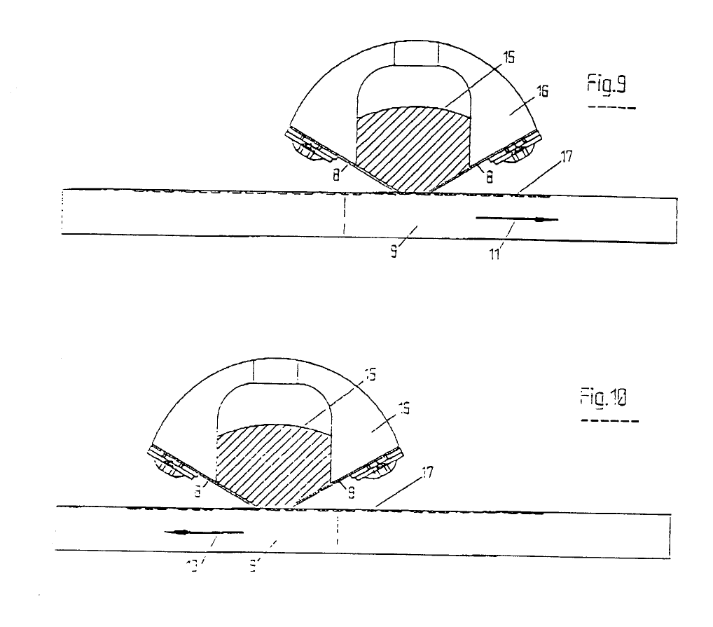

FIGS. 9-12 relate to a variant of the invention.

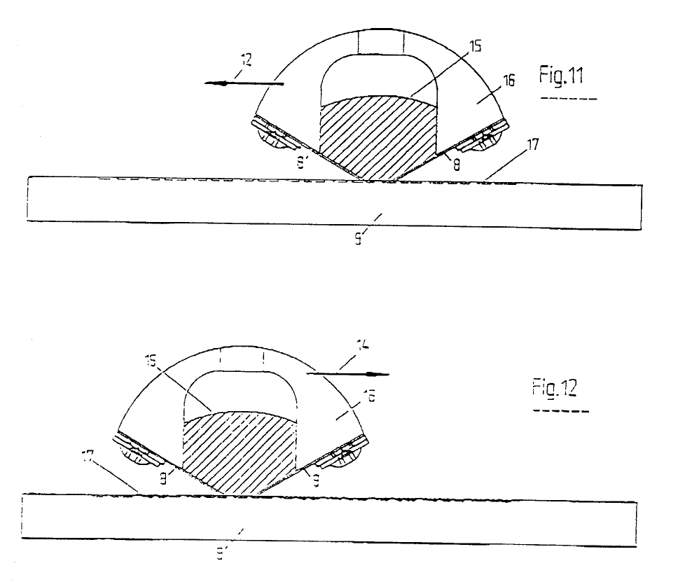

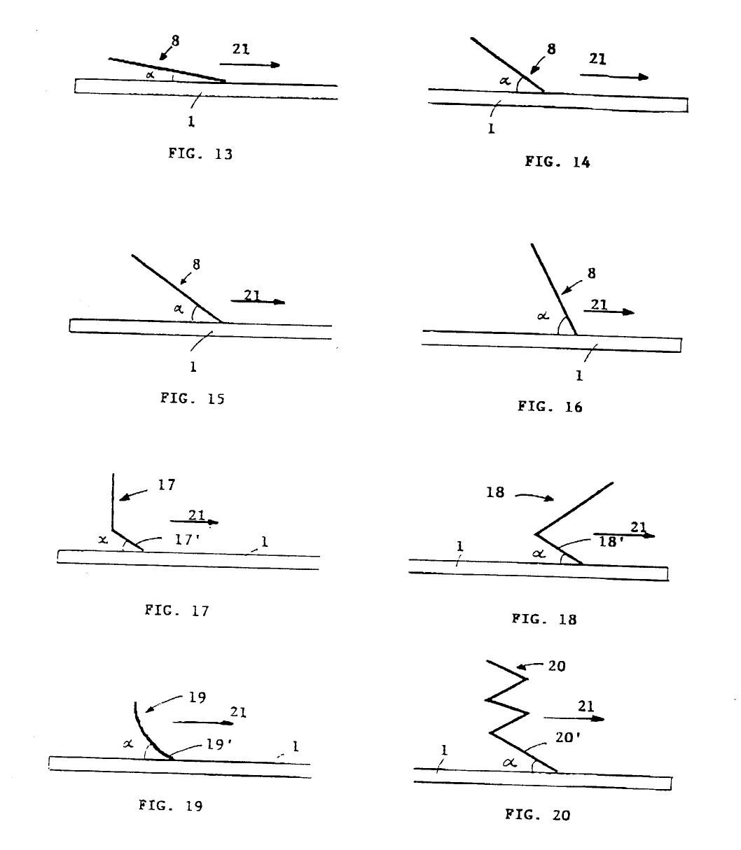

FIGS. 13-16 schematically illustrate several possible adjustments of a flat doctor blade at a negative angle with respect to a printing plate.

FIGS. 17-20 schematically illustrate various possible embodiments of doctor blades according to the invention.

The process according to the invention starts out from the conclusion that the adjustment of a doctor blade at a negative angle with respect to a printing plate, yields surprising results, which then make it possible to assemble a device and to solve with technically reliable means, a number of problems which will be discussed further.

With the expression “negative angle” is meant an angle measured with respect to the portion of the printing plate that is inked and must yet be scraped off.

When reference is now made to FIGS. 1-4, which illustrate the state of the art, 1 is the printing plate. The printing plate 1 is fixed in a frame 2, a deepened part of which forms the ink chamber 3. In this ink chamber 3, the ink is collected after the scraping off of the printing plate. Although several variants of the equipment described here are conceivable, a device for inking a printing plate in principle always comprises an ink slab 4 and a doctor blade 5. Doctor blade and ink slab are seperately moved up and down by electro-mechanical means which do not belong to the field of this invention.

In a process, the defects of which have been described in the preamble, the stage represented in FIG. 1 is thus started from. In this stage, both the doctor blade 5 and the slab 4 are in a position which is removed from the printing plate. The inking stage is shown in FIG. 2. The frame 2 with printing plate 1 is moved here in the sense of arrow 6, while the doctor blade 5 is still removed from the printing plate 2.

In the stage according to FIG. 3, the inking is finished and the doctor blade 5 is brought into contact with the printing plate. During the movement of the frame 2, while the doctor blade 5 is in contact with the printing plate 1, the ink is scraped off and collected in the ink duct 3.

It should be noted that the angle at which the doctor blade is adjusted with respect to the printing plate, is a sharp angle measured with respect to the portion of the printing plate which is covered by ink and must yet be scraped off.

The process according to the invention and the device derived therefrom, essentially differ from the “state of the art”known up to now, in that a doctor blade is brought into action, which is adjusted at a very specific angle with respect to the printing plate.

From the FIGS. 5-8 it shows very clearly, that the doctor blade 8 is at a so-called negative angle with respect to the printing plate 9. With “negative angle” is meant an obtuse angle, measured with respect to the portion of the printing plate 9 which is covered by an ink layer 10 and must yet be scraped off.

The inking stage is elucidated by the FIGS. 5 and 7, whereby in one case the printing plate 9 is moved according to arrow 11, whereas in the other case (FIG. 7) the doctor blade 8 is moved according to arrow 12.

The scraping off stage (FIGS. 6 and 8) also occurs according to two possible patterns, viz. moving of the printing plate 9 according to arrow 13 (FIG. 6), or moving of the doctor blade 8 according to arrow 14 (FIG. 8).

The remarkable thing in the process according to the invention, and in the device derived therefrom, is the choice of an angle allowing to carry out the inking and the scraping off without having to change the distance of the doctor blade with respect to the printing plate. The doctor blade always remains in contact with the printing plate.

Such a remarkable negative angle varies between 90°-180°.

At such an adjustment of a doctor blade 8, the ink tank 15 can take a very original shape, either or not in combination with the doctor blade 8.

In the embodiment shown in FIGS. 5-8, the doctor blade 8 partially closes the nozzle of the ink tank, through which the ink flows away. The doctor blade 8 may be structured completely independently from the ink tank, but both the doctor blade 8 and the ink tank 15 could for example be produced in one piece, together with the package 16, by injection moulding.

Thanks to simple spraying techniques it is then perfectly conceivable to realise the package 16, the ink tank 15 and the doctor blade 8 as a whole, and having regard to the low production costs, to use it as a disposable assembly.

The FIGS. 9-12 show a variant of the invention, in which two doctor blades 8 directed at each other, are fixed adjustably onto the package 16. Between the two doctor blades 8, the ink tank 15 is created.

The FIGS. 13 to 16 very schematically illustrate the principle of the invention. The doctor blades 8 are all directed at the printing plate 1 at α negative angle. With the notion “a angle” is meant the different angles in the different figures.

Finally, FIGS. 17 to 20 represent some peculiar possible embodiments of doctor blades. From these figures it may be clearly derived that the active part of a doctor blade, the bottom edge thereof, which comes into contact with the printing plate, plays an essential role.

FIG. 17 represents a doctor blade 17, which is adjusted at any angle with respect to the printing plate 1, but the bottom edge 17′ of which is directed at the concerned negative angle with respect to the printing plate.

FIG. 18 concerns a doctor blade 18 which is adjusted at a sharp angle with respect to the printing plate, but the bottom edge 18′ of which is also directed at the concerned negative angle.

FIG. 19 represents a doctor blade 19, the bottom edge of which is bent in such a way that the active part 19′ of the doctor blade is always bent at the negative angle according to the invention.

FIG. 20 finally shows a doctor blade 20, which is folded at different sharp angles, and the bottom edge 20′ of which is directed at the printing plate 1 at the desired negative angle.

In all schematically shown embodiments, the direction of motion of the doctor blade is indicated by arrow 21.

From the above given description of the different embodiments, the principle underlying the invention is shown. Claims

1. Process for inking an engraved printing plate from an ink tank and for scraping off the ink in dab printing, characterised in that a doctor blade is used, of which at least the bottom edge, which comes into contact with the printing plate, is adjusted with respect to the printing plate at a negative angle, measured with respect to the portion of the printing plate which is inked and to be scraped off, and without changing the position of the doctor blade, a relative moving of the doctor blade with respect to the printing plate is generated, on the one hand, in a direction to ink the printing plate, and on the other hand, in the other direction, to scrape off the ink from the printing plate.

2. Process according to claim 1, characterised in that for said negative angle a value is chosen between almost 90° and almost 180°.

3. Process according to any one of claims 1 and 2, characterised in that a doctor blade of flexible material is used.

4. Process according to any one of claims 1 and 2, characterised in that a doctor blade of distorsionless material is used.

5. Process according to any one of claims 1-4, characterised in that a distorsionless plate is used as a printing plate.

6. Process according to any one of claims 1-4, characterised in that as a printing plate, a slightly deformable plate is used.

7. Process according to any one of claims 1-6, characterised in that above said printing plate is moved and above said doctor blade is kept immobile.

8. Process according to any one of claims 1-6, characterised in that above said doctor blade is moved and above said printing plate is kept immobile.

9. Process according to any one of claims 1-6, characterised in that above said doctor blade and above said printing plate are moved in the opposite sense.

10. Device for inking a printing plate and for scraping off the ink in dab printing, characterised in that it consists of the combination of:
a) an ink tank for the inking of a printing plate during a relative moving of the printing plate with respect to this ink tank, and of
b) at least one doctor blade, of which the bottom edge, which comes into contact with the printing plate, is adjusted at a negative angle with respect to the printing plate, whereby an angle is meant that is measured with respect to the portion of the printing plate that has been inked and must yet be scraped off.

11. Device according to claim 10, characterised in that above said negative angle is of the order of 90°-180°.

12. Device according to any one of claims 10 and 11, characterised in that above said doctor blade is flat and shows a bottom edge, which is bent at above said negative angle and forms an obtuse angle with the printing plate.

13. Device according to claims 10 and 11, characterised in that above said doctor blade is flat and shows a bottom edge, which is bent at above said negative angle and forms a sharp angle with the printing plate.

14. Device according to any one of claims 10 and 11, characterised in that above said doctor blade is arched and shows a bottom edge, which extends at the above said negative angle.

15. Device according to any one of claims 10 and 11, characterised in that above said doctor blade in height direction, is folded at several sharp angles and shows a bottom edge, which extends at the above said negative angle.

16. Device according to any one of claims 10-15, characterised in that above said ink tank is elongated, and with above said doctor blade forms an elongated ink gap.

17. Device according to claim 16, characterised in that above said doctor blade and ink tank are fixed on a common elongated package.

18. Device according to claim 16, characterised in that above said doctor blade and above said elongated package form a whole.

19. Device according to claim 18, characterised in that above said doctor blade and above said elongated package have been injection moulded from the same material.

20. Device according to any one of claims 10-19, characterised in that two doctor blades are mounted opposite each other.

21. Device according to any one of claims 10-19, characterised in that above said doctor blade forms a closed circuit, and a portion of the doctor blade extends at above said negative angle.
